(19) United States
(12) Patent Application Publication
(10) Pub. No.: US 2013/0013087 A1
(43) Pub. Date: Jan. 10, 2013

(54) METHOD AND SYTEM FOR CONTROLLING AT LEAST ONE DEVICE

(75) Inventors: Dzmitry Viktorovich Aliakseyeu, Eindhoven (NL); Jia Du, Eindhoven (NL); Petronella Hendrika Zwartkruis-Pelgrim, Eindhoven (NL)

(73) Assignee: KONINKLIJKE PHILIPS ELECTRONICS N.V., EINDHOVEN (NL)

(21) Appl. No.: 13/583,806

(22) PCT Filed: Mar. 8, 2011
(86) PCT No.: PCT/IB11/50962

§ 371 Date: Sep. 10, 2012

(30) Foreign Application Priority Data
Mar. 15, 2010 (EP) 10156453.2

(51) Int. Cl. G05B 15/00

(52) U.S. Cl. 700/83

(57) ABSTRACT

A method and system for controlling (210) at least one device. The device is controlled by sensing (208) at least one movement or presence of the user within at least one zone. The location of the zone being defined (202, 206) on the basis of the detected position of the user and updated (206) upon changes in position of the user being detected.

### FIELD OF THE INVENTION

The present invention relates to a method and system for controlling at least one device. In particular, it relates to controlling a device remotely.

### BACKGROUND OF THE INVENTION

Operation of different home appliances including home entertainment systems are, invariably, controlled by a remote control device which is in the form of a hand held device comprising a plurality of push buttons to control various functions of the controlled device. Alternative remote control devices may utilise touch-sensitive screens or speech recognition. However, such device can be difficult to use, particularly if the user is physically disabled, having difficulty holding the device and/or difficulty pushing buttons etc or may be visually impaired making using the device difficult. Furthermore some of these remote control devices require teaching making set up difficult and time consuming. Furthermore, remote control devices are generally small and easily misplaced.

There is therefore a desire to enable to control of various functions of such devices within the limitations of the capabilities of the user, for example may have mild to severe disabilities. This may include a user who is bed-ridden.

Furthermore, in the case of the bedroom environment, users often need to wind down before they can go to sleep. Therefore, the activities that users engage in before going to sleep typically require little mental and physical effort, to avoid the user becoming too alert. The same applies when people wake up during the night. In addition, users do not want to disturb a sleeping partner. This means that users, even if not restricted by disability, are restricted in the freedom to engage in certain activities and also in the freedom to interact with any digital appliances that they might have in their bedroom. Typical examples of bedroom appliances are TVs, music players, alarm clocks, etc. The interaction with these conventional devices is usually not suited for the bedroom environment.

US 2009/0177327 relates to a bed that includes sensors for detecting small deflections caused by the respiration, pulse, motion and presence of a user. The bed also includes a computing unit that controls electronic appliances based on the deflections. For example, if the sensors detect the user leaving the bed, the computing device adjusts the lighting to illuminate a path for the user. However, it is not possible for the user of this system to control specific functions of the appliances without leaving the bed or without using a remote control. The user therefore does not have complete control over the appliances. Furthermore, this system is prone to false activation.

There is therefore a need for a method that allows a user to control specific functions of appliances without leaving the bed or couch and with minimal effort. The method is required to reduce the mental and physical effort needed to control appliances, reduce the effort needed to initiate the interaction and, in the case of people with disabilities, allow the user to control appliances without help and with minimum effort, and to minimize the number of errors.

### SUMMARY OF THE INVENTION

The invention seeks to provide a method and system that allows a user to control specific functions of devices from their current position, with minimal mental and physical effort and with minimum errors.

This is achieved, according to one aspect of the present invention, by a method for controlling at least one device, the method comprising the steps of: regularly detecting the position of a user; defining the location of at least one zone on the basis of the detected position of the user; and updating the at least one zone based on changes in the detected position of the user, wherein at least one movement or presence of the user within the at least one zone controls at least one function of at least one device.

This is also achieved, according to a second aspect of the present invention, by apparatus for controlling at least one device, the system comprising: a detector for regularly detecting the position of a user; a processor for defining the location of at least one zone on the basis of the detected position of the user and for updating the at least one zone based on changes in the detected position of the user, wherein at least one movement or presence of the user within the at least one zone controls at least one function of at least one device.

In this way, the user does not need to change his whole posture to control a device, but needs a minimal effort, e.g. by displacing only his limbs, to activate a particular function of a device. By updating the at least one zone, the probability of false activation is minimized.

The location and/or size of the at least one zone may be updated. In this way the at least one zone can be adapted to various positions of the user, for example lying down, sitting or standing.

The step of regularly detecting the position of a user may comprise regularly detecting a body posture of the user. In this way, the system is aware of whether a user is, for example, lying down, sitting or standing.

The method may further comprise providing visual feedback to the user at a position based on the detected body posture of the user. In this way, the user is provided with visual feedback at the most convenient position for the user thus minimizing the head movement that is required by the user.

The at least one zone may include at least one activation zone for activating or deactivating the at least one device. In this way, the user has complete control over the system.

The at least one activation zone may be located at a distance from the user. This reduces the probability of false activation.

The at least one zone may include at least one other zone for controlling at least one other function of the at least one device. In this way, the user has control of a plurality of device that can each be operated in an easy and effortless way.

Further, a remote control device can still be used in a more conventional way if required. For example, if the user is detected to be in an active position or posture, for example, sitting up they can use the remote control and the zones are no longer in use and may be deactivated. This provides the user with the flexibility to make use of more familiar method to interact with the devices.

The method may further comprise providing visual feedback to the user that indicates where the interaction zones are currently located and optionally which interaction zone can be used to activate which function.

### BRIEF DESCRIPTION OF THE DRAWINGS

For a better understanding of the invention, and to show more clearly how it may be carried into effect, reference will now be made, by way of example only, to the accompanying drawings in which:

FIG. 1 is a simplified schematic of a system for controlling at least one device;

FIG. 2 is a flowchart of a method for controlling at least one device; and

FIG. 3 is a diagram schematically illustrating interaction zones in an embodiment of a system for controlling at least one device.

### DETAILED DESCRIPTION

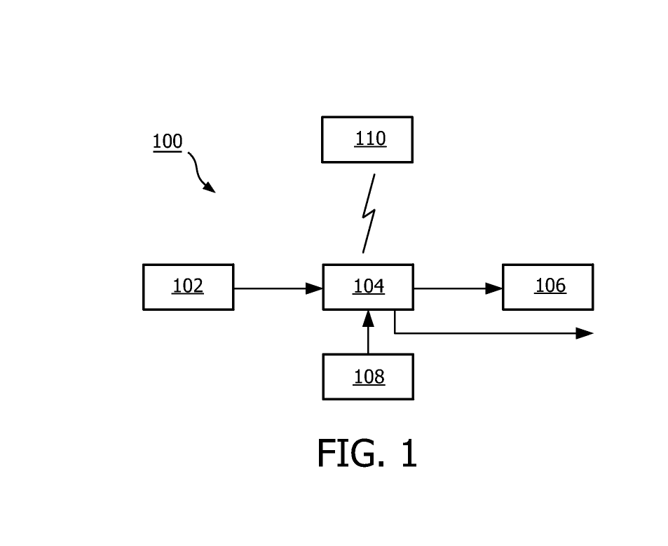

With reference to FIG. 1, the system 100 comprises a detector 102. The output of the detector 102 is connected to a processor 104. The output of the processor 104 is connected to a rendering device 106. The system 100 comprises a sensor 108. The output of the sensor 108 is also connected to the processor 104. These connections may be wired or wireless. The system 100 further comprises a remote control device 110 for wireless communicating with the processor 104. The remote control device 110 may comprise a push button device, a touch-sensitive screen device or a speech recognition device.

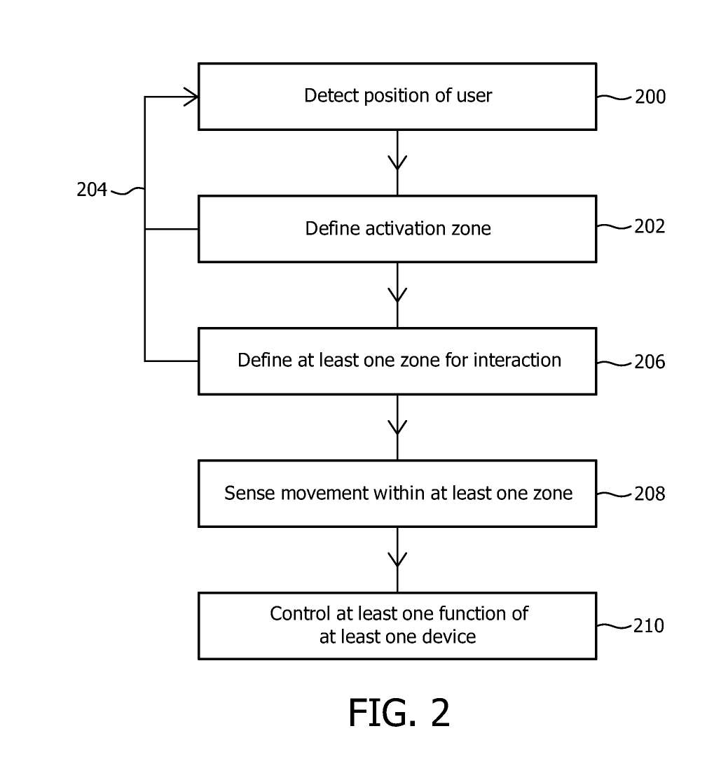

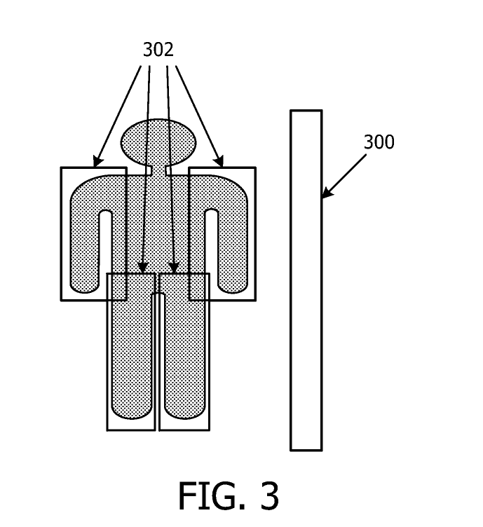

The operation of the system 100 will now be described with reference to the flowchart shown in FIG. 2 and FIG. 3.

The detector 102 of the system 100 regularly detects the position of a user (step 200). The detector 102 may be a location detector that continuously detects the location of the user. For example, a location detector 102 could detect the presence of the user in a room and also the exact location of the user in the room. The detector 102 may, additionally or alternatively, be a posture detector that regularly detects a body posture of the user, e.g. by detecting the position of the user's torso or head and torso. The posture detector may comprise a plurality of pressure sensors incorporated in a pressure sensitive surface. For example, the pressure sensors may be incorporated in a mattress or pressure sensitive bed sheet on a bed, or in the cushion and arms of a chair. Alternatively, the detector 102 may be in the form of a foil in the bed sheet that the user is lying under, which can detect the shape of a user. By adding pressure sensitive sensors to the sheet, the sheet can detect vertical movement, since the pressure becomes stronger on limbs that are raised underneath the sheet. Alternatively, infrared cameras may be used to detect position of the user. The position of the user is detected and updated regularly, for example, at predetermined time intervals. These intervals can be made shorter so that the update appears like a real-time update. Further, if it is determined that the user is not engaged in interaction, only rough estimation of detected position (posture) are provided, for example, only part of the pressure sensors are active and time intervals are longer in a watching mode.

The processor 104 of the system 100 defines an activation zone 300 on the basis of the position of the user detected by the detector 102 such that the activation zone 300 is located at a distance from the user but within hands reach (step 202). The processor 104 updates the location of the activation zone 300 based on changes in the position of the user detected by the detector 102 by detecting the position of the user and redefining the zones by repeating, 204, steps 200, 202, 206 regularly.

A user activates the system 100 by moving a body limb (for example, a hand) into the activation zone 300 and/or by applying pressure to an object (arm of a chair or area of a mattress) within the activation zone 300. For example, if the detector 102 detects that a person is lying on the centre of a bed then the processor 104 will define an activation zone 300 at a location toward the edge of the bed that is within hands reach of the user. This activation zone 300 may include a zone toward the left edge of the bed and a zone toward the right edge of the bed. When a user wishes to activate the system 100 in order to control devices, the user stretches one of his arms to move it into the activation zone 300. The system 100 is then activated and interaction with the device or devices to be controlled is initiated. Activation of the system 100 may also activate the device or devices to be controlled. Further, the system 100 may be activated to switch the system from its watching mode to an active mode in which updates occur more frequently and more sensors are active than in the watching mode.

The processor 104 defines the location of at least one zone 302 on the basis of the position of the user detected by the detector 102 (step 206). The at least one zones 302 provide areas that a user can interact with in order to control devices. The at least one zone 302 is disengaged when the user is asleep to avoid false activation. Also, when another person is present in the same bed, the at least one zone 302 that is close in connection with this person is disengaged to increase the precision of the other at least one zone 302.

The location and/or size of the at least one zone may be defined based on the position of the user. For example if the user is sitting, the zones may be reduced in size compared to similarly located zones defined when the user is standing or lying down.

The processor 104 updates the location of the at least one zone 302 based on changes in the position of the user detected by the detector 102 (step 204). The user is therefore not limited to any posture, position or location in a bed or chair to operate the system 100, since the system 100 regularly takes into account the position of the user such that the location of the at least one zone 302 is updated before the user interacts with the system 100. The at least one zone 302 is defined in such a way that the user does not need to change his posture, needs a minimal effort to activate a particular function and the probability of false activation is minimized.

In order to interact with system 100 while lying in the bed or sitting on the couch, the user moves his body limbs corresponding to the functionality that the user is intending to manipulate. By displacing particular body limbs (e.g. left hand, right foot, left leg, etc) the user can activate and control the specific functions that have been mapped to this particular movement. The displacement can be done both horizontally (e.g. relative position of the limbs) and vertically (e.g. change of pressure applied by the limbs).

The sensor 108 senses the movement of the user within the at least one zone 302 and inputs the sensed movement of the user into the processor 104 (step 208). The processor 104 processes the sensed movement of the user within the at least one zone 302 and controls at least one function of at least one device (step 210) by a control signal output by the processor 104. For example, to turn the volume down on at least one device when lying in bed, the user can simply move his/her arm downwards on the bed (in the direction of the feet). Similarly, to turn the volume down on at least one device when sitting in a chair, the user can simply move his/her hand along an arm of the chair. The sensor 108 senses this movement of the user within the at least one zone 302, inputs the sensed movement into the processor 104, and the processor 104 processes the sensed movement to control the volume function of at least one device.

The processor 104 may control a rendering device 106. The rendering device 106 may be, for example, a screen for providing visual feedback to a user, or an audio system for providing audio feedback to a user.

In the case of the rendering device 106 being a screen, the screen can provide visual feedback to a user at a position based on the detected body posture of the user. The user is not limited to any posture, position or location in a bed or chair to operate the system 100, since the system 100 takes into account the position of the user when providing feedback to the user. For example, if the detector 102 detects the position (location and body posture) of the user to be lying on his back on a bed in the bedroom, the processor 104 will control the rendering device 106 to provide visual feedback on the ceiling directly above the user's head. Alternatively, if the detector 102 detects the position (location and body posture) of the user to be lying on his back on a bed in the bedroom, the processor 104 will control the rendering device 106 to provide visual feedback on the wall directly in front of the user. Alternatively, if the detector 102 detects the position (location and body posture) of the user to be sat upright in a chair in the living room, the processor 104 will control the rendering device 106 to provide visual feedback on the TV screen. This minimizes the head movement that is required by the user.

Further, the detector 102 detects a particular posture of the user, for example, the user may be slouching on a couch. As a result at least one zone for interaction is maintained and defined on basis of the particular position, i.e. location and posture. If the detector 102 detects that user is then in a more upright position the zones are deactivated and the user uses the remote control device 110.

The system according to the embodiment above can be used in a bedroom or in a relaxation setting (for example, in a couch, chair) when changing body posture (i.e. from sitting to standing) to operate a device and can also be used by immobile patients in a hospital and people with disabilities.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for controlling at least one device, the method comprising the steps of:
regularly detecting the position of a user;
defining the location of at least one zone on the basis of the detected position of the user; and
updating the at least one zone based on changes in the detected position of the user,
wherein at least one movement or presence of the user within the at least one zone controls at least one function of at least one device.

2. A method according to claim 1, wherein the step of updating the at least one zone comprises updating the location and/or size of the at least one zone.

3. A method according to claim 1, wherein the step of regularly detecting the position of a user comprises regularly detecting a body posture of the user.

4. A method according to claim 3, the method further comprising providing visual feedback to the user at a position based on the detected body posture of the user.

5. A method according to claim 1, wherein the at least one zone includes at least one activation zone for activating or deactivating the at least one device.

6. A method according to claim 5, wherein the at least one activation zone is located at a distance from the user.

7. A method according to claim 1 further comprising
deactivating the at least one zone on the basis of the detected position of the user; and
controlling at least one function of the at least one device by means of a remote control device.

8. A computer program product comprising a plurality of program code portions for carrying out the method according to claim 1.

9. A system for controlling at least one device, the system comprising:
a detector for regularly detecting the position of a user;
a processor for defining the location of at least one zone on the basis of the detected position of the user and for updating the at least one zone based on changes in the detected position of the user,
wherein at least one movement or presence of the user within the at least one zone controls at least one function of at least one device.

10. A system according to claim 9, wherein the detector is a posture detector for detecting a body posture of the user.

11. A system according to claim 10, wherein the posture detector comprises a plurality of pressure sensors incorporated in a pressure sensitive surface.

12. A system according to claim 10, further comprising a rendering device for providing visual feedback to the user at a position based on the detected body posture of the user.

13. A system according to claim 9, further comprising at least one sensor for sensing the at least one movement or presence of the user within the at least one zone.

14. A system according to claim 9, further comprising a remote control device for controlling at least one function of the at least one device when the at least one zone is deactivated on the basis of the detected position of the user.
